(19) United States
(12) Patent Application Publication
(10) Pub. No.: US 2026/0100006 A1
(43) Pub. Date: Apr. 9, 2026

(54) Activation of Partial Pass-Through on an Artificial Reality Device

(71) Applicant: Meta Platforms Technologies, LLC, Menlo Park, CA (US)

(72) Inventors: Shaik Shabnam NIZAMUDEEN BASHA, London (GB); Peter JU, San Mateo, CA (US); Eric LEUNG, San Francisco, CA (US); Jianhan XU, Vancouver (CA)

(21) Appl. No.: 19/269,920

(22) Filed: Jul. 15, 2025

Related U.S. Application Data
(63) Continuation of application No. 18/148,005, filed on Dec. 29, 2022, now abandoned.
(60) Provisional application No. 63/380,412, filed on Oct. 21, 2022.

(51) Int. Cl. G06T 19/00; G06F 3/04847; G10L 15/18

(52) U.S. Cl. CPC G06T 19/006; G06F 3/04847; G10L 15/1822

(57) ABSTRACT

Some aspects of the present disclosure are directed to providing partial pass-through on an artificial reality (XR) device, such as a head-mounted display (HMD). Some implementations can allow a user to turn on selective areas of pass-through on the XR device, such that one or more portions of a real-world environment physically surrounding the user can be seen. In some implementations, a user can control the area of pass-through by specifying a percentage of the real-world environment he wishes to see, e.g., 50%. In some implementations, a user can control the area of pass-through by specifying an area of XR device she wishes to see, e.g., the top portion of the view. In some implementations, a user can control the area of pass-through by specifying a physical object in the real-world environment he wishes to see, e.g., a real-world desk.

### CROSS REFERENCE TO RELATED APPLICATIONS

This application is a continuation of U.S. patent application Ser. No. 18/148,005, titled “Activation of Partial Pass-Through on an Artificial Reality Device,” filed Dec. 29, 2022, which claims priority to U.S. Provisional Patent Application No. 63/380,412, titled “Activation of Partial Pass-Through on an Artificial Reality Head-Mounted Display,” filed Oct. 21, 2022, both of which are herein incorporated by reference in their entirety.

### TECHNICAL FIELD

The present disclosure is directed to providing partial pass-through on an artificial reality (XR) device, such as a head-mounted display (HMD).

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing partial pass-through on an artificial reality (XR) device, such as a head-mounted display (HMD).

FIG. 6A is a conceptual diagram illustrating an example view on an artificial reality (XR) device, such as a head-mounted display (HMD), with no pass-through view of a real-world environment.

FIG. 6B is a conceptual diagram illustrating an example view on an artificial reality (XR) device, such as a head-mounted display (HMD), with partial pass-through of a real-world environment.

FIG. 6C is a conceptual diagram illustrating an example view on an artificial reality (XR) device, such as a head-mounted display (HMD), with full pass-through of a real-world environment.

FIG. 7 is a conceptual diagram illustrating an example view on an artificial reality (XR) device, such as a head-mounted display (HMD), with partial pass-through of an object in a real-world environment.

FIG. 8 is a conceptual diagram illustrating an exemplary flow for object recognition according to some implementations of the present technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to providing partial pass-through on an artificial reality (XR) device, such as a head-mounted display (HMD). According to some implementations, the XR device can display a fully immersive, computer-generated virtual reality (VR) experience to a user. The XR device can receive a command to activate a pass-through view on the XR device, such as through a voice command or via a selectable element, such as a virtual button or slider. The XR device (or other processing components in operable communication with the XR device) can identify a first portion of the display of XR device in which to activate the pass-through view based on the command. The XR device can then activate the pass-through view on the first portion of the XR device while simultaneously displaying the VR experience on a second portion of the display. The first portion of the XR device can show a real-world environment of the user, either captured by cameras integral with or in operable communication with the XR device (e.g., as in augmented reality), or as can be seen through the display of the XR device (e.g., as in mixed reality).

Thus, some implementations can allow a user to turn on selective areas of pass-through on the XR HMD, such that one or more portions of a real-world environment physically surrounding the user can be seen. In some implementations, a user can control the area of pass-through by specifying a percentage of the real-world environment he wishes to see, e.g., 50%. In some implementations, a user can control the area of pass-through by specifying an area of XR HMD's field of view she wishes to see, e.g., the top portion of the view. In some implementations, a user can control the area of pass-through by specifying a physical object in the real-world environment he wishes to see, e.g., a real-world desk. Such implementations can perform object recognition on the real-world environment to identify objects in the environment and select the object for pass-through based on the command from the user.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Aspects of the present disclosure provide specific improvements in the technical field of artificial reality. For example, some implementations allow a user to select a portion of her real-world environment to simultaneously display alongside a VR experience, without having to exit the VR experience or remove the XR device (e.g., an XR HMD). Thus, the user can continue to engage in the VR experience while also seeing her surroundings, and potentially performing other tasks. In other words, some implementations can allow a user to multitask while enjoying a VR experience. Some implementations can be particularly useful for a user to avoid tripping on objects in his real-world environment (e.g., when a pass-through view of the floor is activated) and/or see moveable objects in his real-world environment (e.g., pets), thereby allowing for seamless integration between reality and virtual reality. Further, by not requiring that the VR experience be fully rendered on the XR device while activating partial pass-through (and when not desired or necessary), compute resources can be conserved, such as processing power, battery power, display resources, etc. Such resources can therefore be allocated to performing other fundamental and necessary tasks on the XR device, thereby improving processing speed and latency.

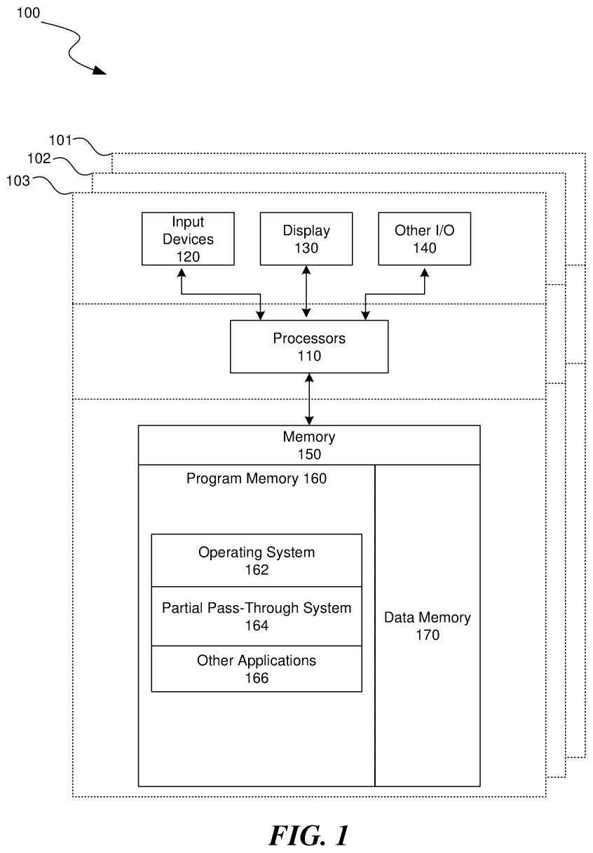

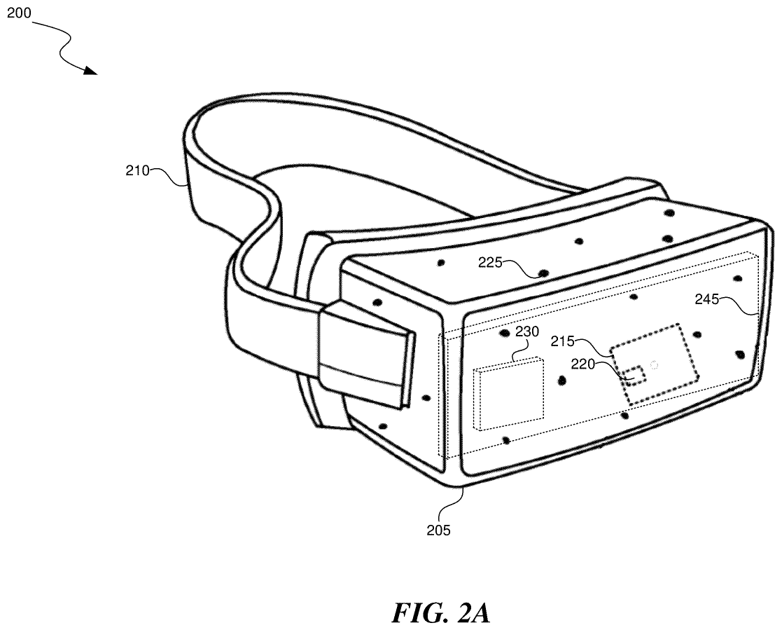

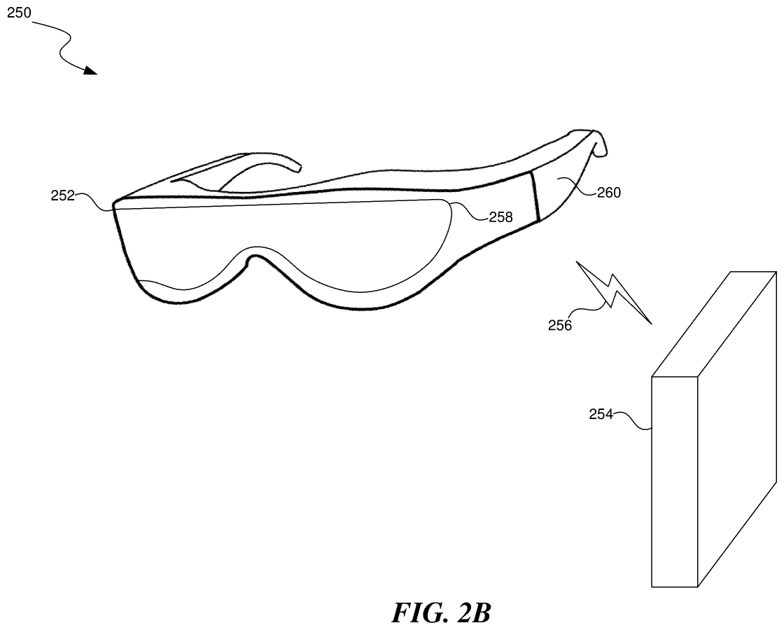

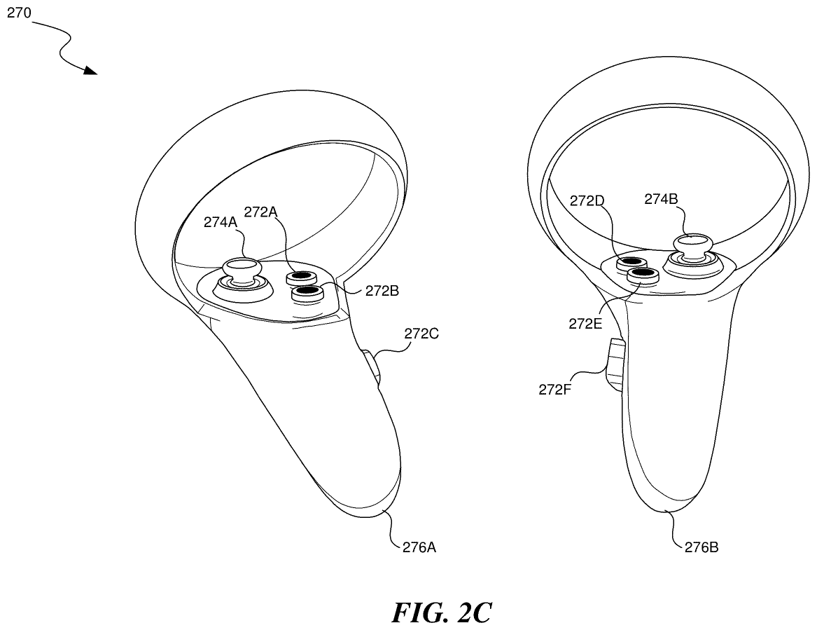

Several implementations are discussed below in more detail in reference to the figures. FIG. 1 is a block diagram illustrating an overview of devices on which some implementations of the disclosed technology can operate. The devices can comprise hardware components of a computing system 100 that can provide partial pass-through on an artificial reality (XR) head-mounted display (HMD). In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, partial pass-through system 164, and other application programs 166. Memory 150 can also include data memory 170 that can include, e.g., virtual reality (VR) rendering data, augmented reality (AR) rendering data, real-world environment rendering data, command data, natural language processing data, object recognition data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

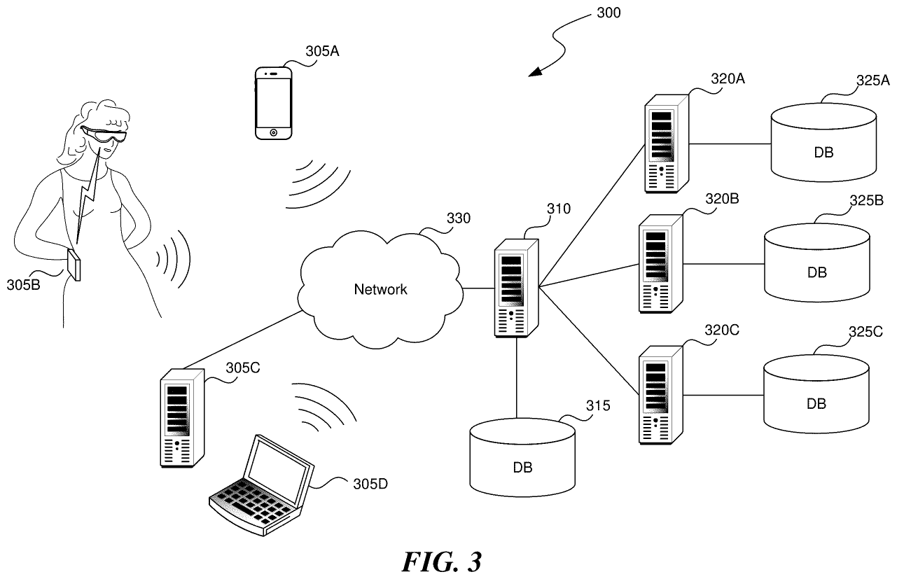

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

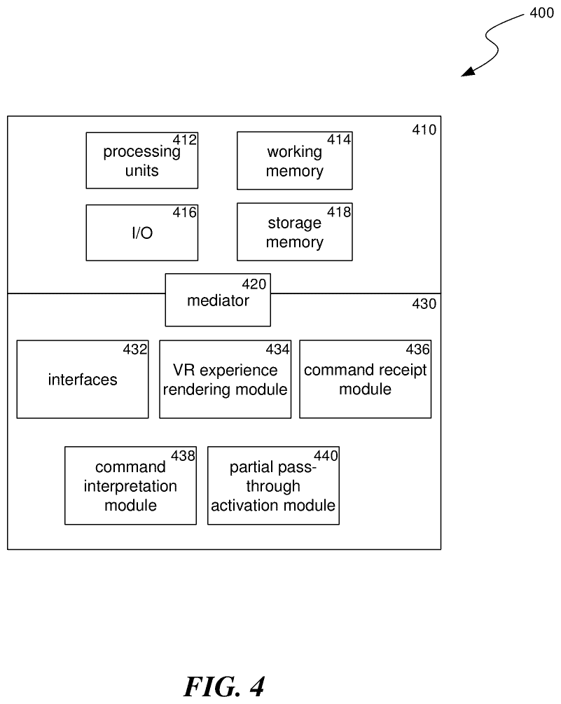

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing partial pass-through on an artificial reality (XR) device, such as a head-mounted display (HMD). Specialized components 430 can include VR experience rendering module 434, command receipt module 436, command interpretation module 438, partial pass-through activation module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

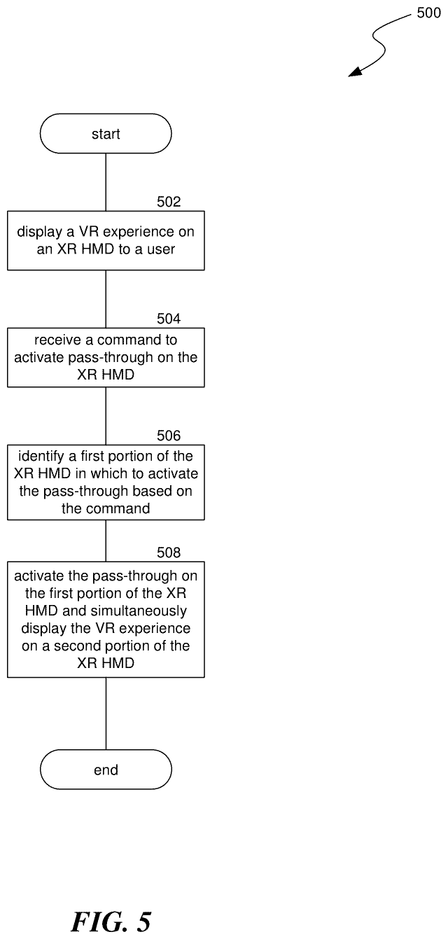

VR experience rendering module 434 can facilitate display of a virtual reality (VR) experience on an artificial reality (XR) device, such as a head-mounted display (HMD). In some implementations, VR experience rendering module 434 can display the VR experience on a display included in input/output devices 416. In some implementations, VR experience rendering module 434 can facilitate display of the VR experience on the XR device by providing data needed to render and/or display the VR experience on the XR device, without itself displaying the VR experience. The VR experience can be any fully immersive VR application, game, virtual world, etc., that can be rendered on an XR device to display a computer-generated virtual environment including virtual objects. Further details regarding displaying a VR experience on an XR device to a user are described herein with respect to block 502 of FIG. 5.

Command receipt module 436 can receive a command to activate a pass-through view on the XR device. Command receipt module 436 can receive the command from one or more devices included in input/output device 416. For example, command receipt module 436 can receive an audible command from a microphone included in input/output devices 416. In another example, command receipt module 436 can receive a command as a physical selection of a physical button included in input/output devices 416 (e.g., on the XR device, via a controller in operable communication with the XR device, etc.), the button being associated with activating and/or deactivating the pass-through view on the XR device. In still another example, command receipt module 436 can receive a command as a gesture captured by a camera included in input/output devices 416, the gesture being associated with activating and/or deactivating the pass-through view on the XR device, e.g., a pointing gesture toward a virtual button or virtual slider, or circling gesture in an area viewable by the XR device. Further details regarding receiving a command to activate a pass-through view on an XR device are described herein with respect to block 504 of FIG. 5.

Command interpretation module 438 can identify a portion of the XR device in which to activate the pass-through view based on the command. In some implementations, when the command is audible, command interpretation module 438 can apply speech recognition and/or natural language processing techniques to parse the command to determine a portion of the XR device in which to activate the pass-through view, e.g., a certain area (“the lower portion of the display”), a certain percentage (“25% of the display”), or a certain object (“the table in my room”). In some implementations, when the command is received via a virtual slider, command interpretation module 438 can identify the corresponding percentage portion of the XR device in which to display the pass-through view. In some implementations, when the command is a gesture in front of the XR device, command interpretation module 438 can identify the portion of the real-world environment corresponding to where the gesture was made with respect to the XR device. Further details regarding identifying a portion of the XR device in which to activate a pass-through view based on a command are described herein with respect to block 506 of FIG. 5.

Partial pass-through activation module 440 can activate the pass-through view on the portion of the XR device identified by command interpretation module 438. In some implementations, partial pass-through activation module 440 can activate the pass-through view by capturing images of the real-world environment from a camera integral with the XR device pointing away from the user and toward a real-world environment. Partial pass-through activation module 440 can simultaneously continue to display the VR experience on the remainder of the XR device not having pass-through activated. Thus, in some implementations, partial pass-through activation module 440 can provide an augmented reality (AR) experience. Further details regarding activating a pass-through view on a portion of the XR device and simultaneously displaying a VR experience on the remaining portion of the XR device are described herein with respect to block 508 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing partial pass-through on an artificial reality (XR) device, such as a head-mounted display (HMD). In some implementations, process 500 can be performed as a response to a user request to activate a pass-through view on a portion of the XR device. In some implementations, some or all process 500 can be performed by the XR device. In some implementations, the XR device can be an XR HMD, such as XR HMD 200 of FIG. 2A and/or XR HMD 252 of FIG. 2V. In some implementations, some of process 500 can be performed by one or more other components of an XR system other than the XR device, such as processing components in operable communication with the XR device. In some implementations, some of process 500 can be performed by a server located remotely from the XR device. In some implementations, process 500 can be performed by partial pass-through system 164 of FIG. 1. In some implementations, process 500 can be performed by specialized components 430 of FIG. 4.

At block 502, process 500 can display a virtual reality (VR) experience on the XR device to a user. The VR experience can be any fully immersive experience in which the user's visual input is fully controlled by the XR device. For example, the VR experience can be a VR application, a VR game, a virtual world, a virtual environment including virtual objects, etc., that is fully created and rendered by the XR device, processing components in operable communication with the XR device, and/or a platform or other computing system hosting the VR experience.

At block 504, process 500 can receive a command to activate a pass-through view on the XR device. In some implementations, the pass-through view can be associated with a world-locked area in a real-world environment of the user. The world-locked area can include physical objects that do not move in response to movement of the XR device, although physical objects within the world-locked area can move independently without regard to movement of the XR device in some implementations (e.g., a human, a pet, a ball, etc.). In some implementations, the physical objects in the world-locked area can be static and stay at the same position and orientation in the real-world environment. In some implementations the command can describe and/or identify the world-locked area in the real-world environment.

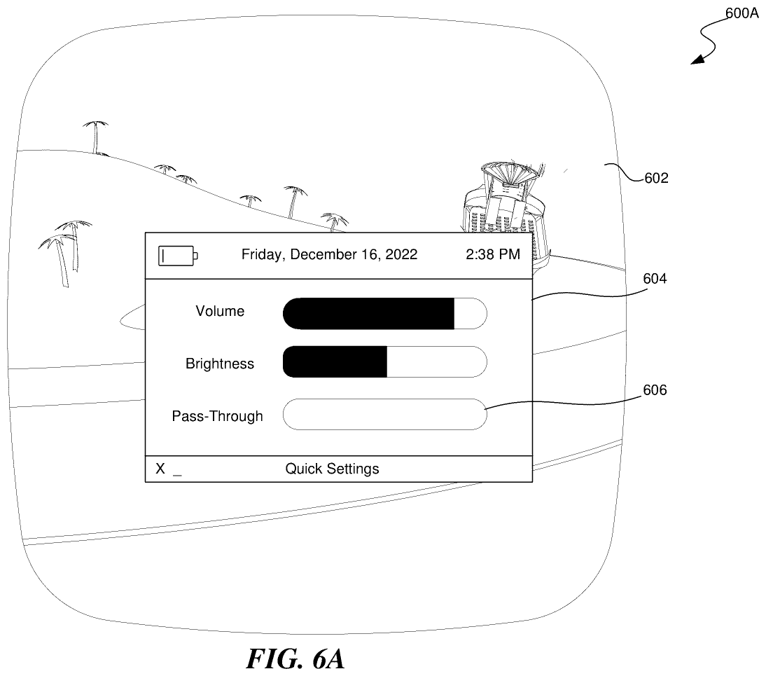

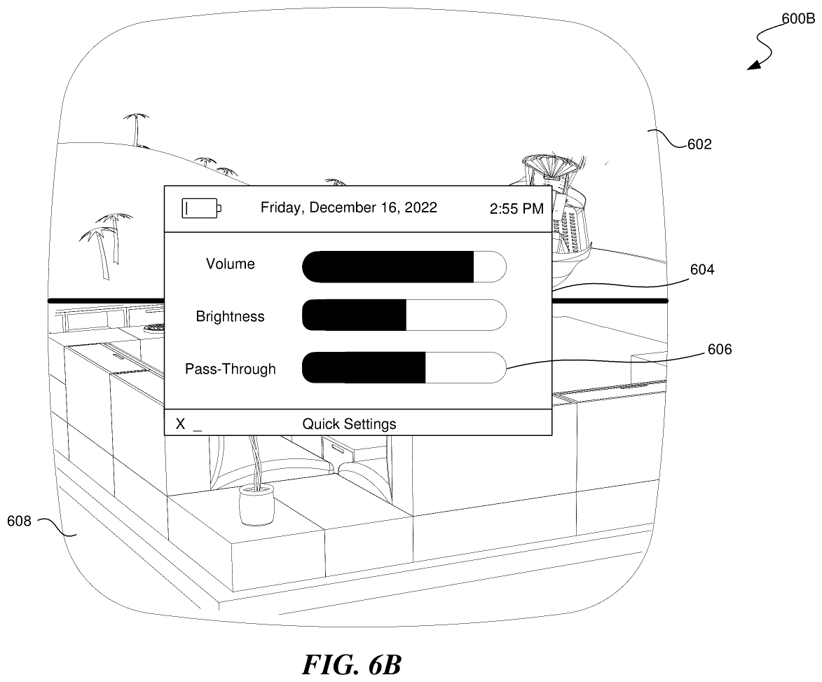

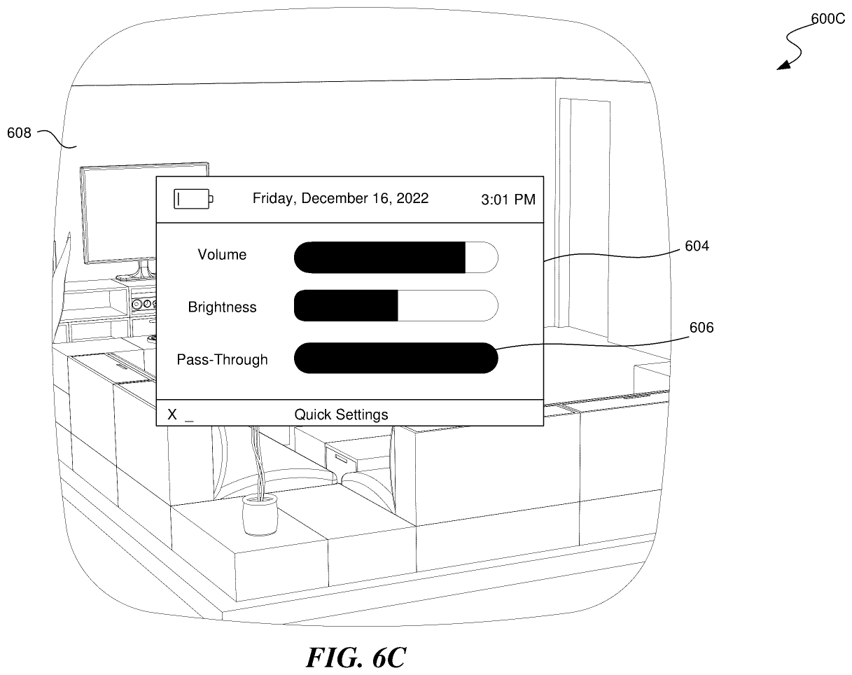

In some implementations, the command can be a user selection of a virtual slider displayed on the XR device, as described further herein with respect to FIGS. 6A-6C. In some implementations, process 500 can receive the user selection via selection of a physical button on the XR device or other XR device in operable communication with the XR device (e.g., a controller). In some implementations, process 500 can receive the user selection via a gesture detected by the XR device (e.g., via a camera or other image capture device) or other XR device in operable communication with the XR device (e.g., a controller having sensors capable of detecting gestures).

In some implementations in which the command is a user selection of a virtual slider, process 500 can further correlate the virtual slider to a dynamic partition on the XR device. The dynamic partition can virtually split the display of the XR device into first and second portions (e.g., first and second sides). Process 500 can determine a location of the dynamic partition on the XR device based on the user selection on the virtual slider. For example, if user slides the virtual slider halfway to its capacity, process 500 can determine that the dynamic partition should split the display of the XR device into halves. It is contemplated the dynamic partition can split the display of the XR device in any direction and/or with any shape, e.g., horizontally, vertically, diagonally, with a curved shape or any other particular shape within the display, etc.

In some implementations, the command can be audible and captured by a microphone in operable communication with and/or integral with the XR device. In such implementations, process 500 can perform speech recognition and/or natural language processing techniques in order to parse and identify the command. In some implementations, the command can identify the first portion of the XR device as a percentage of the XR device (e.g., “activate pass-through for the lower 50% of the display”). In some implementations, the command can identify the first portion of the artificial reality head-mounted display as an object in the real-world environment (e.g., “show me my desk on the display”or “activate pass-through for the door in my room”).

In some implementations, process 500 can generate the command automatically. For example, the user of the XR device can activate a setting (and/or process 500 can automatically select a setting) to activate the pass-through view for particular object(s) that would otherwise come within the field-of-view of the user in the real-world environment from within a VR experience. For example, process 500 can perform object recognition and/or object detection to identify objects that the user may want to see in pass-through, such as physical objects on the floor that may trip the user. In another example, process 500 can perform object recognition, object detection, and/or motion detection to identify moving objects that the user may want to see in pass-through, such as humans or animals that may physically get in the way of the user or that may want to interact with the user while the user is in the VR experience.

At block 506, process 500 can identify a first portion of the XR device in which to activate the pass-through view based on the command. In some implementations in which the pass-through view is associated with a world-locked area in a real-world environment of the user, the first portion of the XR device can correspond to the world-locked area associated with the pass-through view. In some implementations, the command received at block 504 can identify the world-locked area as an object in the real-world environment. In some implementations, the object can be a moving object (e.g., a human, a pet, a ball, a vacuum robot, etc.).

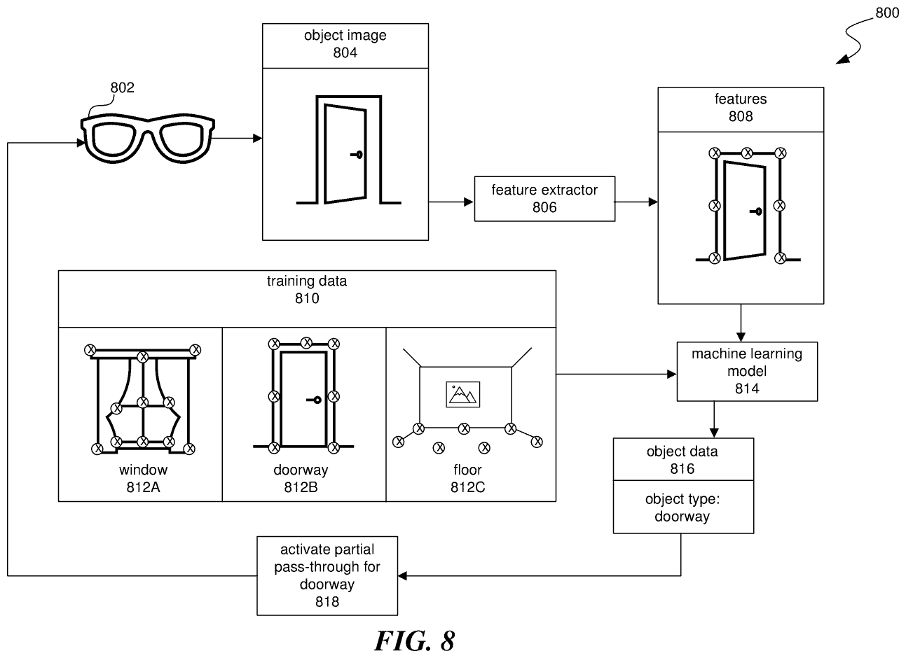

In some implementations, process 500 can identify an object specified by the command and/or the location of the object specified by the command by performing object recognition and/or object detection in the real-world environment. For example, process 500 can use a machine learning and/or deep learning model to identify physical objects in the real-world environment. Process 500 can train the model based on known objects typically present in a user's real-world environment, such as windows, doors, furniture, animals, trees, etc. In some implementations, process 500 can identify features in the known objects, e.g., corresponding to edges, corners, and other unique and/or identifying features. Process 500 can then receive an input image captured by a camera integral with the XR device, extract features in objects present in the image, and compare the extracted features to the identified features in the known objects to identify the objects with some degree of certainty. Further details regarding object recognition and machine learning models are described herein with respect to FIG. 8.

In some implementations, process 500 can identify the object specified by the command and/or the location of the object specified by the command by accessing at least one of scene data, spatial anchor data, or both, associated with the real-world environment of the user. For example, as the XR device (and/or other XR devices) are moved around the real-world environment, they can scan those locations and define certain anchor points (e.g., at surfaces, edges, corners, doorways, etc.) These spatial anchors can specify a map of the world around that XR device. These spatial anchors can then be stored to either locally or to a centralized mapping service. When the same or another XR device is in a similar location in the real-world environment, it can identify spatial anchors and also retrieve spatial anchors for that area either locally or from the mapping service. By aligning one or more of the spatial anchors the XR device has detected with corresponding spatial anchors from the mapping service, the XR device can identify itself within the map defined by the greater set of anchor points from the mapping service. Using this map, the XR device can then track itself in the real-world environment. The XR device (or another XR device having accessed the real-world environment) can scan the area to specify object locations and types within a defined scene lexicon (e.g., desk, chair, wall, floor, ceiling, doorway, etc.). This scene identification can be performed, e.g., through a user manually identifying a location with corresponding object types or with a camera to capture images of physical objects in the scene and use computer vision techniques to identify the physical objects as object types. The object types can be stored in relation to one or more of the spatial anchors defined for that area, which can be used by process 500 to identify objects and/or locations of objects in the real-world environment in some implementations. In some implementations, process 500 can access such scene data from a central system, from local storage, and/or from another XR device having previously generated the scene data.

In some implementations in which the command received at block 504 identifies a percentage of the XR device in which to activate the pass-through view, process 500 can allocate the percentage of the XR device to the pass-through view on the first portion of the XR device. Process 500 can further identify a second portion of the XR device in which to display at least a part of the VR experience by allocating a remaining percentage of the XR device to at least the part of the VR experience on the second portion of the XR device.

In some implementations in which the command received at block 504 is a user selection of a virtual slider displayed on the XR device, process 500 can identify the first portion of the XR device by allocating a first side of a dynamic partition to the first portion of the XR device in which to activate the pass-through view, based on the location of the dynamic partition. In some implementations, process 500 can identify the first portion of the XR device in which to activate the pass-through view by correlating the position of the virtual slider to a percentage of the XR device. Process 500 can further allocate a second side of the dynamic partition to a second portion of the XR device in which to display at least a part of the XR experience, based on the location of the dynamic partition, e.g., the remaining percentage of the XR device.

At block 508, process 500 can activate the pass-through view on the first portion of the artificial reality head-mounted display and simultaneously display the VR experience on a second portion of the artificial reality head-mounted display. The first portion of the XR device can show a real-world environment of the user corresponding to the portion identified by the command. In some implementations, process 500 can display a feed of the real-world environment of the user captured by a camera in operable communication with and/or integral with the XR device. Thus, in some implementations, the XR device can display an augmented reality (AR) experience having pass-through partially on the XR device, and a VR experience on the remaining area of the XR device.

In some implementations, the pass-through view can include a view of a head-locked area in the real-world environment (i.e., a view of the real-world environment that changes as the XR device moves on the user's head), such as when the pass-through view is for a percentage of the XR device (e.g., the upper 50% of the display). In some implementations, the pass-through view can include a view of a world-locked area in the real-world environment. In some implementations in which the pass-through view is associated with the world-locked area, the pass-through view can remain fixed to the world-locked area while the XR devices moves. For example, in some implementations, process 500 can further fix the pass-through view to the world-locked area in the real-world environment by tracking movement of the XR device with respect to the world-locked area. In some implementations, process 500 can further update, based on the tracked movement, the first portion of the XR device through which the pass-through view is activated. In some implementations, the pass-through can be activated for a moving object in the real-world environment. In such implementations, process 500 can fix the pass-through view to the world-locked area by further tracking movement of the moving object with respect to the XR device.

In some implementations in which the command received at block 504 identifies a percentage of the XR device in which to activate the pass-through view, process 500 can crop the VR experience to correspond to the second portion of the XR device. For example, if the command is to activate a pass-through view on the left 25% of the display of the XR device, process 500 can crop the left 25% of the VR experience, and display the remaining 75% of the VR experience on the right 75% of the display. In some implementations, process 500 can resize, shrink, and/or change the aspect ratio of the VR experience to fit the second portion of the XR device.

FIG. 6A is a conceptual diagram illustrating an example view 600A on an artificial reality (XR) device, such as a head-mounted display (HMD), with no pass-through view of a real-world environment. View 600A includes VR experience 602. View 600A further includes virtual menu 604 having virtual slider 606, which, in view 600A, is set to 0% pass-through. Thus, view 600A includes VR experience 602 displayed on 100% of the XR device.

FIG. 6B is a conceptual diagram illustrating an example view 600B on an artificial reality (XR) device, such as a head-mounted display (HMD), with partial pass-through of a real-world environment 608. View 600A includes virtual menu 604 having virtual slider 606, which, in view 600B, is set to 60% pass-through. Thus, view 600B includes VR experience 602 displayed on 40% of the XR device, and real-world environment 608 displayed on 60% of the XR device. In some implementations, real-world environment 608 can be captured by one or more cameras integral with or in operable communication with the XR device.

FIG. 6C is a conceptual diagram illustrating an example view 600C on an artificial reality (XR) device, such as a head-mounted display (HMD), with full pass-through of a real-world environment 608. View 600A includes virtual menu 604 having virtual slider 606, which, in view 600C, is set to 100% pass-through. Thus, view 600C includes real-world environment 608 displayed on 100% of the XR device. In some implementations, real-world environment 608 can be captured by one or more cameras integral with or in operable communication with the XR device.

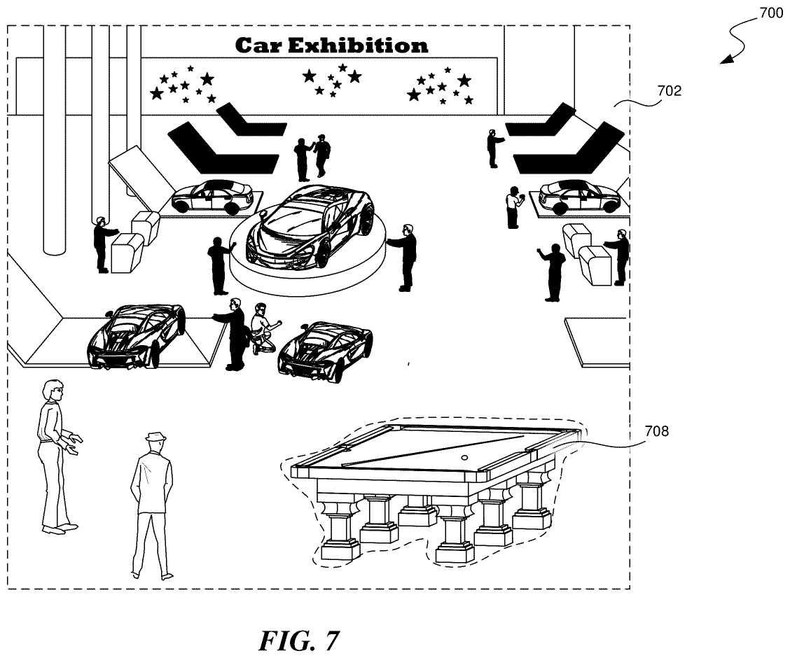

FIG. 7 is a conceptual diagram illustrating an example view 700 on an artificial reality (XR) device, such as a head-mounted display (HMD), with partial pass-through of an object 708 in a real-world environment. View 700 can include VR experience 702; in this case, a virtual car exhibition. View 700 can further include pass-through of object 708 (as indicated by the broken like around object 708 indicating a passthrough area) in a user's real-world environment; in this case, a real-world pool table. Some implementations can activate pass-through for object 708 in response to a user command, e.g., an audible command to “turn on pass-through for the pool table in my room.” Some implementations can identify object 708 by performing object recognition on images captured of the user's real-world environment, and performing speech recognition and natural language processing techniques to link the command to object 708.

FIG. 8 is a conceptual diagram illustrating an exemplary flow 800 for object recognition according to some implementations of the present technology. In some implementations, flow 800 can be performed to identify particular objects in the user's real-world environment for which the user requests partial activation of pass-through. XR device 802 can capture object image 804; in this case, an image including a doorway. For example, one or more image capture devices (e.g., one or more cameras) integral with and/or in operable communication with XR device 802 can capture object image 804 (and, in some implementations, images of other real-world objects) in the field-of-view of a user of XR device 802. For example, in some implementations, XR device 802 can capture object image 804 including a doorway, a plant, a window, etc., and perform flow 800 to identify the doorway from within object image 804.

Some implementations can also receive contextual factors surrounding the object image 804, such as where the image was captured (e.g., in the living room, at a movie theater, at a restaurant, in an office, etc.), when the image was captured (e.g., morning, noon, night, late night, on a holiday, on a weekend, etc.), audio occurring when the image was captured (e.g., a user discussing or announcing his surroundings, conversations, etc.), what the user was doing when the image was captured (e.g., watching a movie, working on a computer, etc.), and/or any other contextual data that may be relevant to identifying an object type, such as environmental factors (e.g., the temperature, the weather, etc.).

XR device 802 can be, for example, an HMD, such as any one of HMD 200 of FIG. 2A, HMD 252 of FIG. 2B, and/or any other components of an XR system in operable communication with an HMD. Object image 804 can be fed into feature extractor 806 that can identify relevant features 808 in object image 804. The relevant features 808 can correspond to, for example, edges, corners, shapes, curvatures, colors, or textures, or any combination thereof. Features 808 can be fed into machine learning model 814.

Machine learning model 814 can obtain training data 810 including labeled object types with identified features; for example, window 812A, doorway 812B, and floor 812C. Some implementations can train machine learning model 814 using a collection of images having known object types and applying a feature extraction algorithm (e.g., via feature extractor 806) to manually extract features of the image, such as edge or corner features, that can be used to differentiate between the object types. Some implementations can train machine learning model 814 by analyzing a large set of training images with known object types and/or contextual factors, and automatically learning the object types'inherent features. Some implementations can map the features of the training images into a classification space identifying the candidate object type associated with those features, to create training data 810. Some implementations can further include past feedback on whether previous object type predictions were correct within training data 810. Some implementations can repeat the training phase of machine learning model 814 until a suitable accuracy level is reached, e.g., as identified by applying a loss function, such as when a sufficient amount of training data 810 has been processed and predictions made by machine learning model 814 do not deviate too far from actual results.

Once trained, machine learning model 814 can generate an output using features 808, training data 810, and, in some implementations, any contextual factors. In some implementations, machine learning model 814 can map features 808 as data points of an output vector in a classification space using training data 810. Using the output vector, machine learning model 814 can compare features 808 to training data 810 to generate a match score between features 808 and training data 810 in the classification space by calculating a distance between the output vector and the candidate object types in training data 810. The match score can be any numerical or textual value or indicator, such as a statistic or percentage.

In this case, machine learning model 814 can determine that the type of object in object image 804 has a highest match score with doorway 812B. Thus, in some implementations, features 808 do not necessarily have to match all of the features of doorway 812B; however, machine learning model 814 can determine that the identified features 808 in object image 804 are more similar to doorway 812B than to window 812A or floor 812C. In some implementations, machine learning model 814 can determine that features 808 have a match score above a predetermined threshold with doorway 812B.

Machine learning model 814 can output object data 816. In some implementations, machine learning model 814 can output object data 816 to XR device 802 in order to activate partial pass-through for the doorway at block 818. Some implementations can receive feedback about the predicted object type, e.g., whether partial pass-through was activated for the correct object. In some implementations, the feedback can be explicit, e.g., the user audibly announces that the predicted object type is correct or incorrect, the user audibly announces that partial pass-through was activated for an incorrect object, the user selects a virtual button indicating that partial pass-through was activated for the correct or incorrect object, etc. In some implementations, the feedback can be implicit, e.g., the user does not correct the partial pass through activation.

Some implementations can update machine learning model 814 and/or training data 810 based on any feedback. For example, based on the feedback data, some implementations can evaluate machine learning model 814 with metrics, for example. The metrics can include accuracy, precision, F1 score, Mean Squared Error, etc. Some implementations can feed these metrics back into machine learning model 814 to refine and update model 814, if necessary. In another example, some implementations can use the feedback data to identify whether the predicted object type was correct or incorrect (and, if incorrect, what the correct object type was, if available), and use that information as a comparison factor to update the model and/or the classification space. Some implementations can weigh the current or updated training data more heavily than the initial or past training data 810, as the later training data can be considered more relevant and/or accurate. Although illustrated as a single flow 800, it is contemplated that flow 800 can be performed multiple times and/or repeatedly, either consecutively or concurrently, as additional object images are received for a particular scene.

Thus, some implementations of the partial pass-through system can include a machine learning component, such as a neural network, that is trained using a variety of data, including images of known object types, past object types seen by the user or similar users, contextual factors, and/or whether the user identified a predicted object type as correct or incorrect. Some implementations can feed input data including an image of an object and/or contextual factors into the trained machine learning component, and based on the output, can generate a predicted object type. Some implementations provide this predicted object type to a user via a display on an XR device by activating partial pass-through for the predicted object. Some implementations receive feedback about the predicted object type to further enhance the trained model.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the trained model can be a neural network with multiple input nodes that receive input data including an image of an object and/or any contextual factors. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value classifying the input that, once the model is trained, can be used to predict an object type in the image. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes images of known object type and/or any contextual factors as input and a desired output, such as a prediction of an object type. A current image of an object can be provided to the model. Output from the model can be compared to the desired output for that object type, and, based on the comparison, the model can be modified, such as by changing weights between nodes of the neural network or parameters of the functions used at each node in the neural network (e.g., applying a loss function). After applying each of the factors in the training data and modifying the model in this manner, the model can be trained to evaluate new input data.

Some implementations of the partial pass-through system can include a deep learning component. A “deep learning model,” as used herein with respect to object recognition, refers to a construct trained to learn by example to perform classification directly from images. The deep learning model is trained by using a large set of labeled data and applying a neural network as described above that includes many layers. With respect to object recognition from images, the deep learning model in some implementations can be a convolutional neural network (CNN) that is used to automatically learn an object's inherent features to identify the object. For example, the deep learning model can be an R-CNN, Fast R-CNN, or Faster-RCNN. In some implementations, object recognition can be performed using other object recognition approaches, such as template matching, image segmentation and blob analysis, edge matching, divide-and-conquer search, greyscale matching, gradient matching, pose clustering, geometric hashing, scale-invariant feature transform (SIFT), histogram of oriented gradients (HOG), region-based fully convolutional network (R-FCN), single shot detector (SSD), spatial pyramid pooling (SPP-net), etc.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1-20. (canceled)

21. A method comprising:
providing first information that causes display of a virtual environment on a display of a headset;
detecting an object in the real-world environment, wherein the object is within a field-of-view of a camera of the headset; and
based at least in part on the detected object, providing second information that causes display of a pass-through view of the object on a first portion of the display of the headset, wherein the pass-through view is fixed relative to a world-locked area, of the real-world environment, including the object, wherein the first portion of the display on which the pass-through view is displayed varies as headset movement is tracked relative to the detected object, and wherein at least a portion of the virtual environment is displayed on the display simultaneously with the pass-through view.

22. The method of claim 21, wherein the detected object is a person, and wherein the method further comprises:
determining that the person wants to interact with a user wearing the headset, wherein the second information is provided in response to said determination.

23. The method of claim 21, further comprising:
determining that the detected object will get in the way of a user wearing the headset, wherein the second information is provided in response to said determination.

24. The method of claim 23, wherein the detected object is a tripping hazard for the user.

25. The method of clam 21, wherein the world-locked area tracks motion of the object in the real-world environment.

26. The method of claim 21, wherein the object is detected using a machine learning model.

27. The method of claim 21, wherein the object is a person.

28. The method of claim 21, wherein the second information is provided based on a setting to provide the pass-through view.

29. A non-transitory computer-readable storage medium storing instructions that, when executed by a computing system, cause the computing system to:
provide first information that causes display of a virtual environment on a display of a headset;
detect an object in the real-world environment, wherein the object is within a field-of-view of a camera of the headset; and
based at least in part on the detected object, provide second information that causes display of a pass-through view of the object on a first portion of the display of the headset, wherein the pass-through view is fixed relative to a world-locked area, of the real-world environment, including the object, wherein the first portion of the display on which the pass-through view is displayed varies as headset movement is tracked relative to the detected object, and wherein at least a portion of the virtual environment is displayed on the display simultaneously with the pass-through view.

30. The non-transitory computer-readable storage medium of claim 29, wherein the detected object is a person, and wherein the instructions, when executed, further cause the computing system to:
determine that the person wants to interact with a user wearing the headset, wherein the second information is provided in response to said determination.

31. The non-transitory computer-readable storage medium of claim 29, wherein the instructions, when executed, further cause the computing system to:
determine that the detected object will get in the way of a user wearing the headset, wherein the second information is provided in response to said determination.

32. The non-transitory computer-readable storage medium of claim 31, wherein the detected object is a tripping hazard for the user.

33. The non-transitory computer-readable storage medium of clam 29, wherein the world-locked area tracks motion of the object in the real-world environment.

34. The non-transitory computer-readable storage medium of claim 29, wherein the object is detected using a machine learning model.

35. The non-transitory computer-readable storage medium of claim 29, wherein the object is a person.

36. The non-transitory computer-readable storage medium of claim 29, wherein the second information is provided based on a setting to provide the pass-through view.

37. A computing system comprising:
one or more processors; and
one or more memories storing instructions that, when executed by the one or more processors, cause the computing system to:
provide first information that causes display of a virtual environment on a display of a headset;
detect an object in the real-world environment, wherein the object is within a field-of-view of a camera of the headset; and
based at least in part on the detected object, provide second information that causes display of a pass-through view of the object on a first portion of the display of the headset, wherein the pass-through view is fixed relative to a world-locked area, of the real-world environment, including the object, wherein the first portion of the display on which the pass-through view is displayed varies as headset movement is tracked relative to the detected object, and wherein at least a portion of the virtual environment is displayed on the display simultaneously with the pass-through view.

38. The computing system of claim 37, wherein the detected object is a person, and wherein the instructions, when executed, further cause the computing system to:
determine that the person wants to interact with a user wearing the headset, wherein the second information is provided in response to said determination.

39. The computing system of claim 37, wherein the instructions, when executed, further cause the computing system to:
determine that the detected object will get in the way of a user wearing the headset, wherein the second information is provided in response to said determination.

40. The computing system of claim 37, wherein the world-locked area tracks motion of the object in the real-world environment.
